(19) United States
(12) Patent Application Publication
(10) Pub. No.: US 2011/0285846 A1
(43) Pub. Date: Nov. 24, 2011

(54) ELECTRONIC DEVICE AND METHOD FOR MONITORING SPECIFIED AREA

(75) Inventors: HOU-HSIEN LEE, Tu-Cheng (TW); CHANG-JUNG LEE, Tu-Cheng (TW); CHIH-PING LO, Tu-Cheng (TW)

(73) Assignee: HON HAI PRECISION INDUSTRY CO., LTD., Tu-Cheng (TW)

(21) Appl. No.: 12/948,777

(22) Filed: Nov. 18, 2010

(30) Foreign Application Priority Data
May 19, 2010 (TW) 99115900

(51) Int. Cl. H04N 7/18

(52) U.S. Cl. 348/143; 348/E07.085

(57) ABSTRACT

A method for monitoring a specified area using an electronic device sets a detection region and a detection mode in a captured image of an image capturing device using a display screen of the electronic device, and sends the detection region and the detection mode to a host computer. The method further displays an image sent from the host computer on the display screen upon the condition that the host computer detects a missed object or a leaving object in the image according to the detection region and the detection mode.

### BACKGROUND

1. Technical Field

Embodiments of the present disclosure relate to security surveillance technology, and particularly to an electronic device and method for monitoring a specified area using the electronic device.

2. Description of Related Art

Image capturing devices have been used to perform security surveillance by capturing images of a number of monitored areas, and sending the captured images to a monitor computer. The monitor computer may detect a missed object or a leaving object in a preset detection region of the captured images according to a preset detection mode (e.g., a missed object detection mode or a leaving object detection mode).

However, the detection region and the detection modes need to be changed using detection software installed in the monitor computer. That is to say, if an administrator wants to change the detection region and the detection mode, the administrator has to go back to the monitor computer. Accordingly, it is inefficient to control the security surveillance. Therefore, an efficient method for monitoring a specified area is desired.

### BRIEF DESCRIPTION OF THE DRAWINGS

FIG. 1 is a schematic diagram of one embodiment of a system for monitoring a specified area using an electronic device.

FIG. 2 is a block diagram of one embodiment of an electronic device.

FIG. 3 is a flowchart of one embodiment of a method for monitoring a specified area using the electronic device.

FIG. 4 is a detailed flowchart of one embodiment of block S1 in FIG. 3.

FIG. 5 is a detailed flowchart of one embodiment of block S5 in FIG. 3.

FIG. 6 is a detailed flowchart of one embodiment of block S6 in FIG. 3.

FIGS. 7A-7C are schematic diagrams of interfaces of setting a detection region in block S1.

FIG. 8 is a schematic diagram of one embodiment of different selection mode to set detection regions.

FIG. 9 is a schematic diagram of interfaces in block S5 when a missed object is detected.

FIG. 10 is a schematic diagram of interfaces in block S6 when a leaving object is detected.

### DETAILED DESCRIPTION

All of the processes described below may be embodied in, and fully automated via, functional code modules executed by one or more general purpose electronic devices or processors. The code modules may be stored in any type of non-transitory readable medium or other storage device. Some or all of the methods may alternatively be embodied in specialized hardware. Depending on the embodiment, the non-transitory readable medium may be a hard disk drive, a compact disc, a digital video disc, a tape drive or other suitable storage medium.

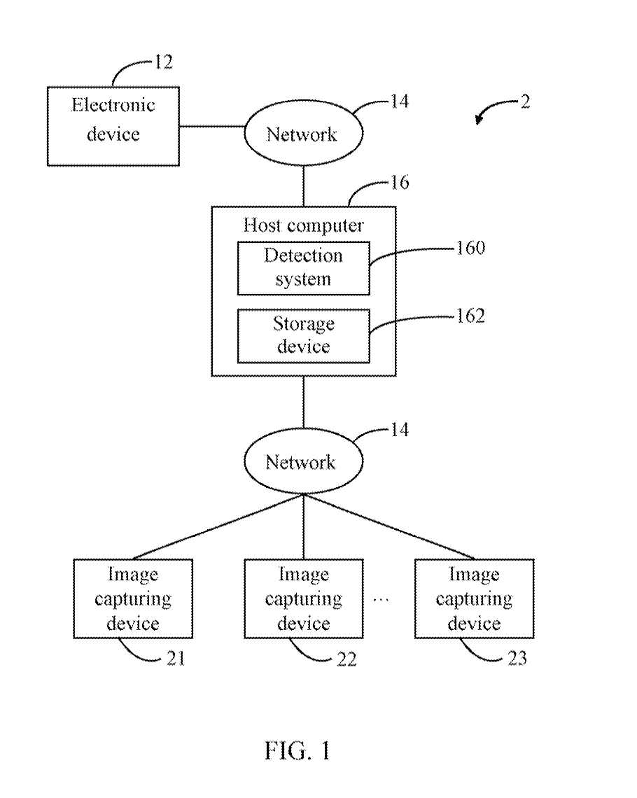

FIG. 1 is a schematic diagram of one embodiment of a system 2 for monitoring a specified area using an electronic device 12. In one embodiment, the system 2 includes the electronic device 12, a host computer 16, and a number of image capturing devices 21, 22, and 23. The host computer 16 is connected to the electronic device 12 and the image capturing devices 21, 22, and 23 through a network 14. In one embodiment, the network 14 may be an intranet, the Internet or other suitable communication network. The image capturing devices 21, 22, and 23 may be speed dome cameras or pan/tilt/zoom (PTZ) cameras, for example. It is may be understood that more than three image capturing devices can be used in other embodiments.

In one embodiment, the host computer 16 may include a detection system 160 and a storage device 162. The detection system 160 may be used to determine a detection region and a detection mode of an image capturing device (e.g., the image capturing device 21) according to information sent from the electronic device 12, detect a missed object or a leaving object in a specified monitored area according to the detection region and the detection mode, and send a detection result to the electronic device 12. Detailed descriptions will be given in the following paragraphs.

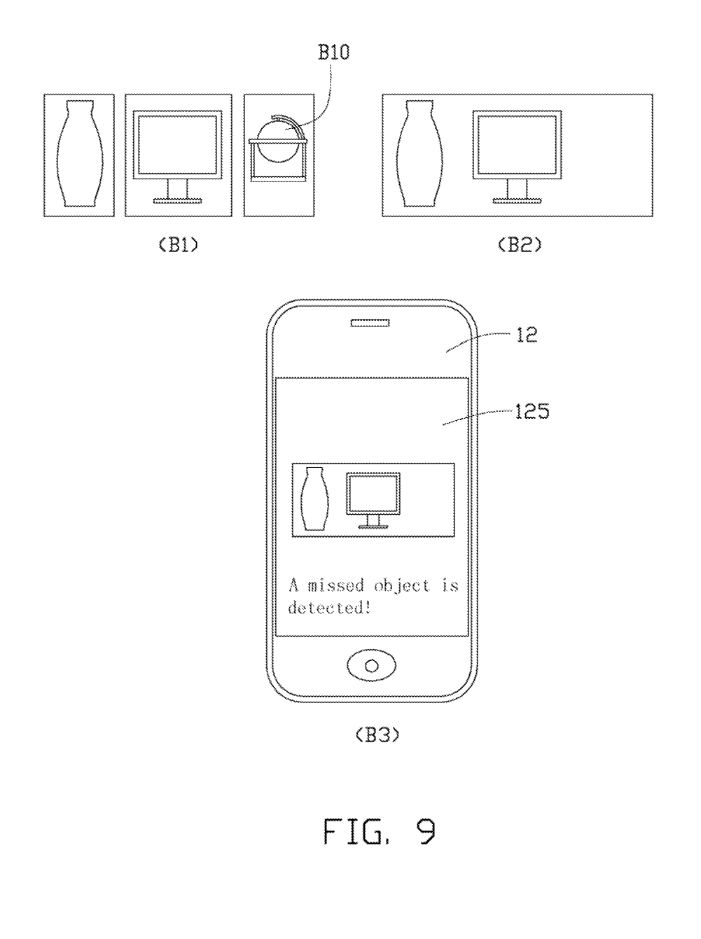

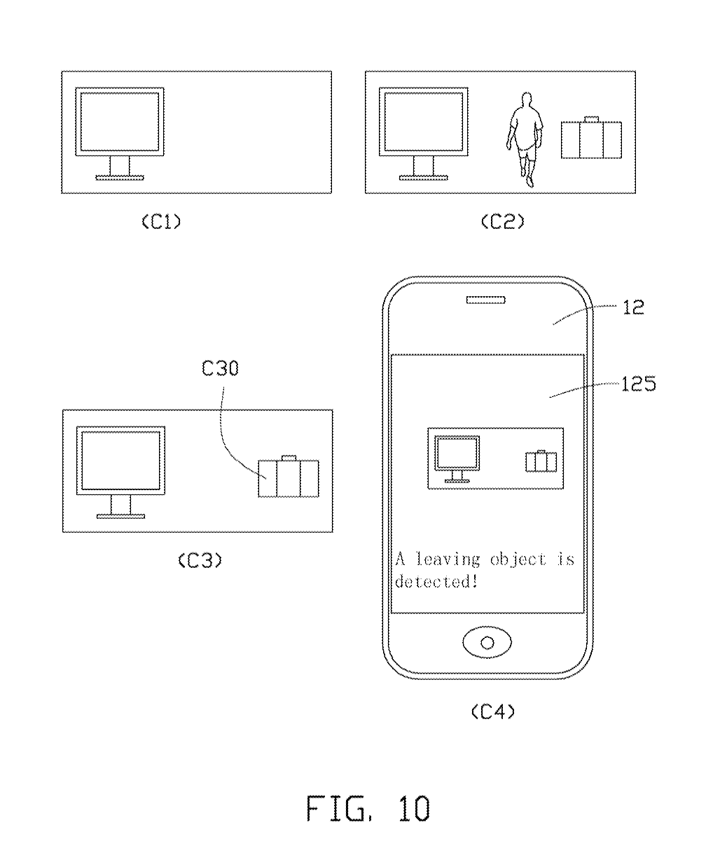

In one embodiment, the detection mode may include a missed object detection mode and a leaving object detection mode, the detection region is an area of a captured image of the image capturing device used to detect the missed object or the leaving object. In one embodiment, the missed object may be an object has exited the monitored area (refer to FIG. 9), and the leaving object may be an object has entered the monitored area (refer to FIG. 10).

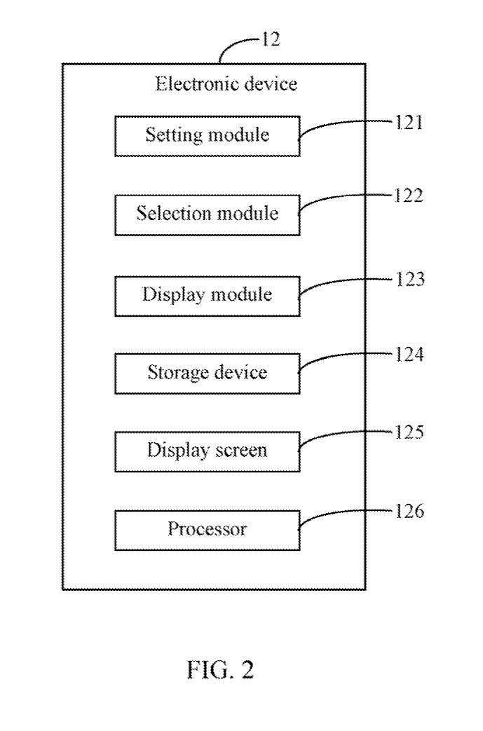

FIG. 2 is a block diagram of one embodiment of the electronic device 12. In one embodiment, the electronic device 12 may include a setting module 121, a selection module 122, a display module 123, a storage device 124, a display screen 125, and at least one processor 126.

In one embodiment, the display screen 125 may be a liquid crystal display (LCD) or a touch-sensitive display, for example. The electronic device 21 may be a mobile phone, a personal digital assistant (PDA) or other suitable communication device.

In one embodiment, the modules 121-123 may comprise computerized code in the form of one or more programs that are stored in the storage device 124 (or memory). The computerized code includes instructions that are executed by the at least one processor 126 to provide functions for the modules 121-123. Detailed descriptions of each of the modules 121-123 will be given in the following paragraphs.

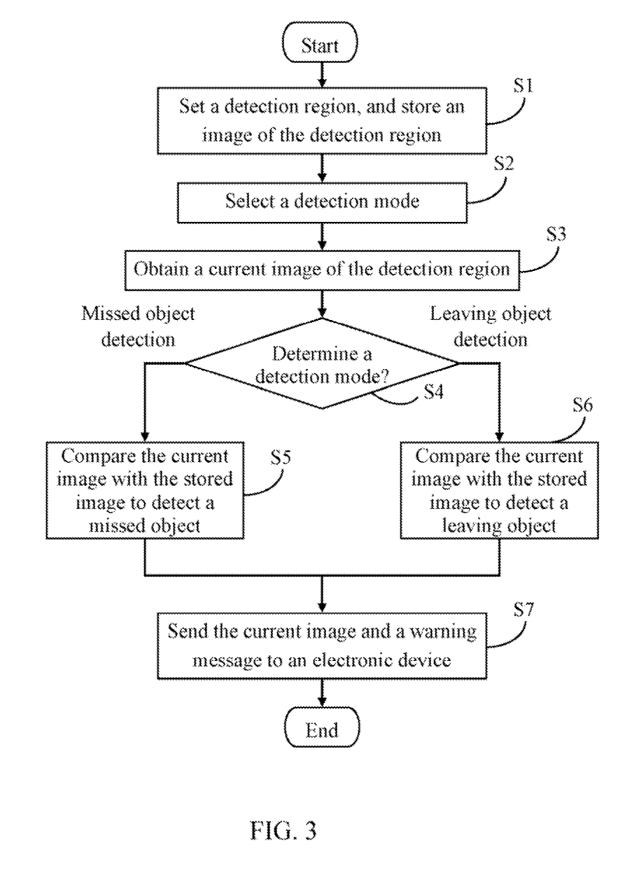

FIG. 3 is a flowchart of one embodiment of a method for monitoring a specified area using the electronic device 12. Depending on the embodiment, additional blocks may be added, others removed, and the ordering of the blocks may be changed.

In block S1, the setting module 121 sets a detection region in a captured image of the image capturing device (e.g., the image capturing device 21) on the display screen 125 of the electronic device 11 in response to receiving user operations on the captured image, and sends the detection region to the host computer 16. The host computer 16 obtains an image of the detection region from one or more of the image capturing devices 21, 22 and 23 after the detection region is set, and stores the image of the detection region in the storage device 162. In one embodiment, the stored image of the detection region is regarded as a reference image of the detection region to detect a missed object or a leaving object in the specified monitored area.

In block S2, the selection module 122 determines a detection mode of the detection region from the storage device 124 of the electronic device 12 in response to receiving user selections. The selection module 122 sends the detection mode of the detection region to the host computer 16 through the network 14. In one embodiment, the detection mode may include the missed object detection mode and the leaving object detection mode.

In block S3, the detection system 160 of the host computer 16 obtains a current image of the detection region captured by the image capturing device after a preset time interval (e.g., 10 seconds).

In block S4, the detection system 160 determines if the detection mode is the missed object detection mode or the leaving object detection mode. If the detection mode is the missed object detection mode, the procedure goes to block S5. Otherwise, if the detection mode is the leaving object detection mode, the procedure goes to block S6.

In block S5, the detection system 160 compares the current image of the detection region with the stored image of the detection region to detect a missed object. Then, the procedure goes to block S7.

In block S6, the detection system 160 compares the current image of the detection region with the stored image of the detection region to detect a leaving object. Then, the procedure goes to block S7.

In block S7, the detection system 160 sends the current image of the detection region and a warning message to the electronic device 12 if the missed object or the leaving object is detected. The display module 125 of the electronic device 12 displays the current image of the detection region and the warning message on the display screen 125. It may be understood that the procedure returns to block S3 if the missed object and the leaving object are not detected.

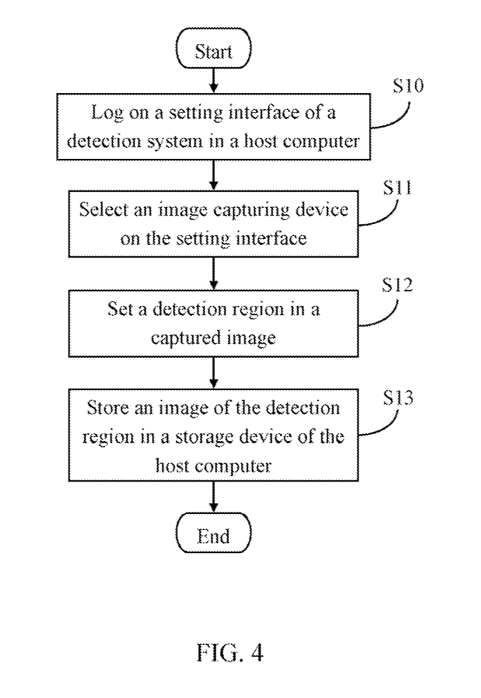

FIG. 4 is a detailed flowchart of one embodiment of block Si in FIG. 3. Depending on the embodiment, additional blocks may be added, others removed, and the ordering of the blocks may be changed.

In block S10, a user logs on a setting interface of the detection system 160 in the host computer 16 using the electronic device 12 through the network 14.

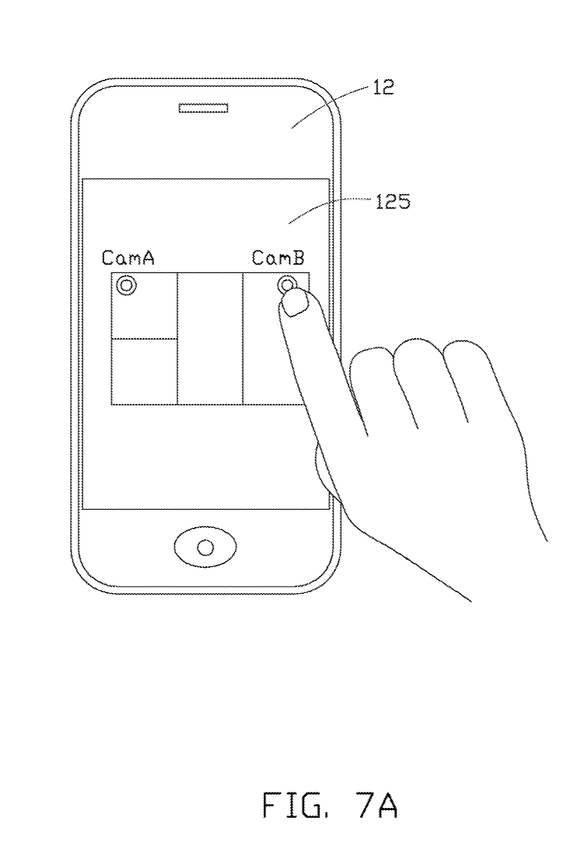

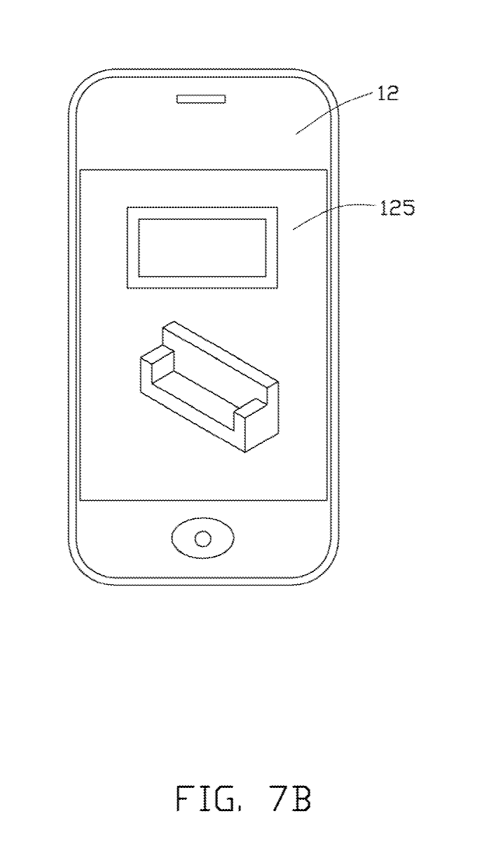

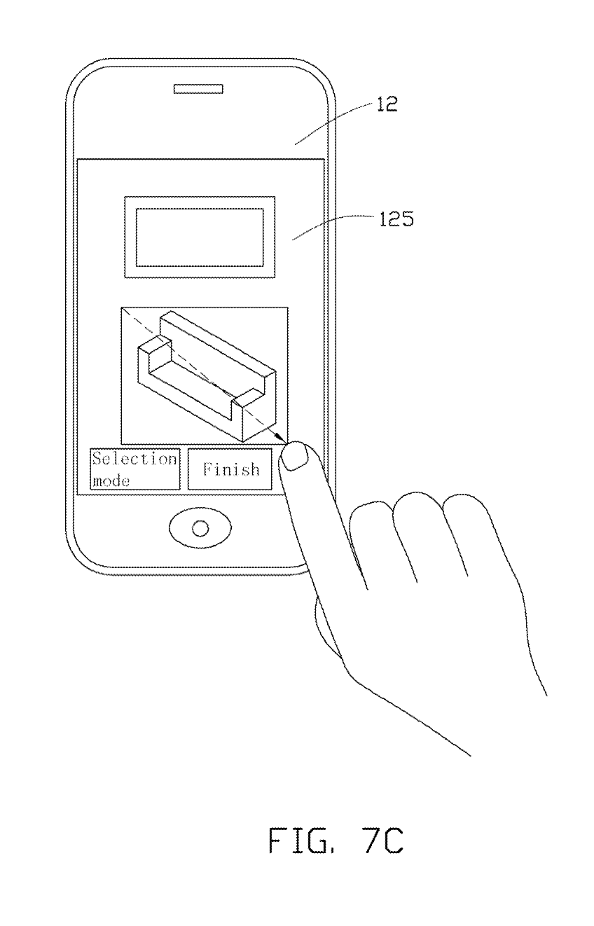

In block S11, the user selects an image capturing device from a number of image capturing devices 21, 22 and 23 on the setting interface of the detection system 160. Referring to FIG. 7A, the icons of “CamA” and “CamB” represent two image capturing devices installed at different locations. Then, an image captured by the selected image capturing device is displayed on the display screen 125 of the electronic device 12 (refers to FIG. 7B).

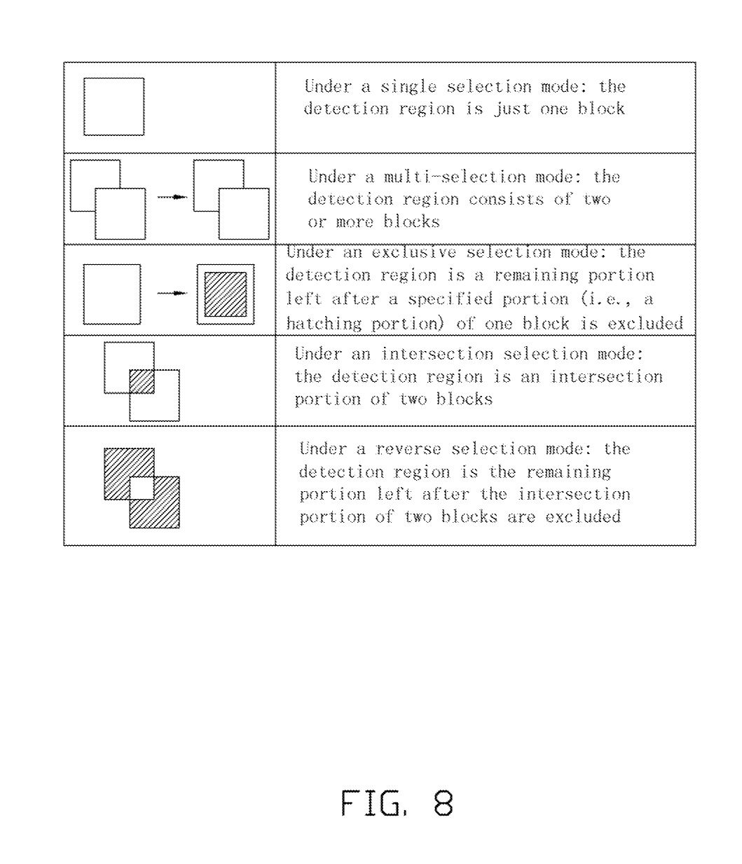

In block S12, the user determines a selection mode to a set a detection region in the captured image sent from the host computer 16 (refers to FIG. 7C). In one embodiment, as shown in FIG. 8, the selection mode may include, but are not limited to a single selection mode, a multi-selection mode, an exclusive selection mode, an intersection selection mode, and a reverse selection mode. The detection region is just one block under the single selection mode. The detection region consists of two or more blocks under the multi-selection mode. The detection region is a remaining portion left after a specified portion (i.e., a hatching portion) of one block is excluded under the exclusive selection mode. The detection region is an intersection portion of two blocks under the intersection selection mode. The detection region is the remaining portion left after the intersection portion of two blocks are excluded under the reverse selection mode.

In block S13, the detection system 160 of the host computer 16 obtains an image of the detection region captured by the selected image capturing device when the detection region setting is finished, and stores the image of the detection region in the storage device 162 of the host computer 16.

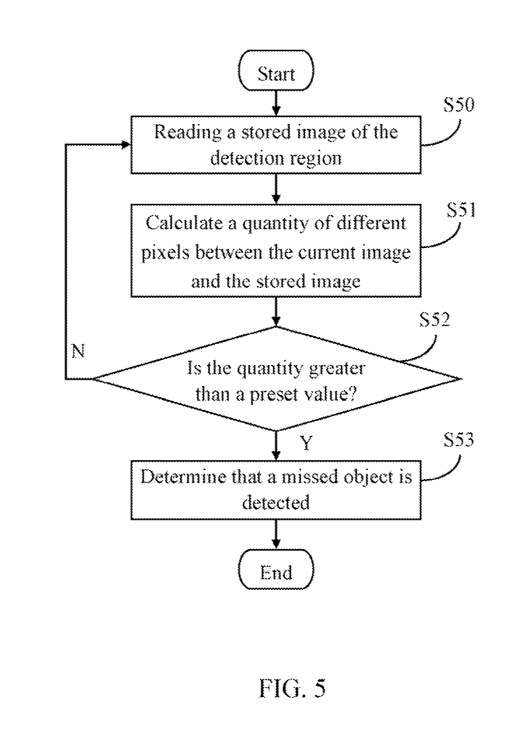

FIG. 5 is a detailed flowchart of one embodiment of block S5 in FIG. 3. Depending on the embodiment, additional blocks may be added, others removed, and the ordering of the blocks may be changed.

In block S50, the detection system 160 reads the stored image of the detection region from the storage device 162 of the host computer 16.

In block S51, the detection system 160 calculates a quantity of different pixels between the current image and the stored image of the detection region. In one embodiment, the different pixels refer to each pixel in the image whose difference value of red, green, and blue (RGB) is less than a preset value (e.g., twenty four). The difference value of RGB of each pixel is equal to a difference value between an RGB value of the pixel in the current image and an RGB value of a corresponding pixel in the stored image. In other embodiment, the detection system 160 can calculate each pixel whose difference value of YCbCr or other suitable difference value is less than a corresponding preset value from the current image and the stored image. In YCbCr, Y is the brightness (luma), Cb is blue minus luma (B-Y), and Cr is red minus luma (R-Y).

In block S52, the detection system 160 determines if the quantity of the different pixels is greater than a preset threshold value. If the quantity of the different pixels is greater than the preset threshold value, the procedure goes to block S53. Otherwise, if the quantity of the different pixels is less than or equal to the preset threshold value, the procedure returns to block S50. In one embodiment, the preset threshold value is equal to twenty percent of the entire pixels in the current image of the detection region.

In block S53, the detection system 160 determines that the missed object is detected. As shown in FIG. 9, “B1” represents the stored image of the detection region, “B2” represents the current image of the detection region, “B3” represents a display interface on the display screen 125 of the electronic device 12. A missed object of “B10” is detected in the current image “B2.”

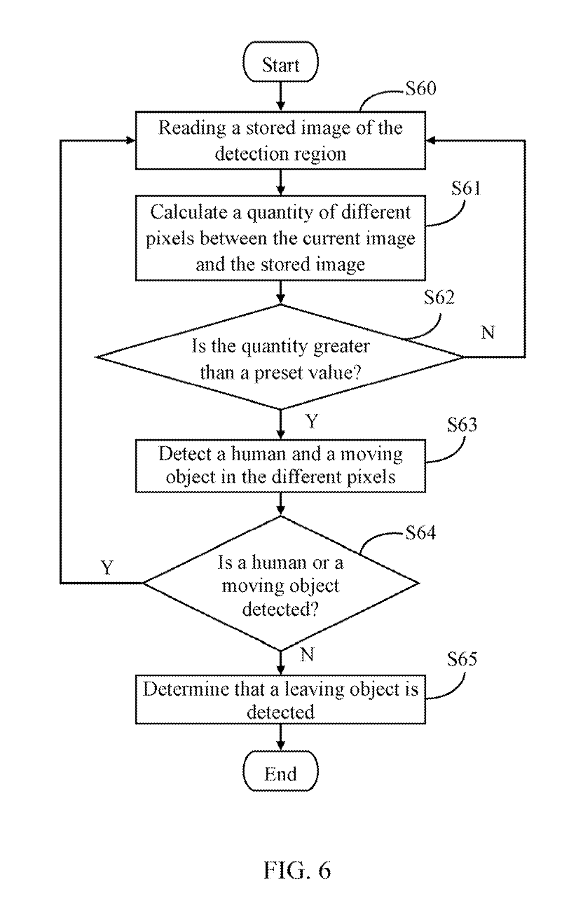

FIG. 6 is a detailed flowchart of one embodiment of block S6 in FIG. 3. Depending on the embodiment, additional blocks may be added, others removed, and the ordering of the blocks may be changed.

In block S60, the detection system 160 reads the stored image of the detection region from the storage device 162 of the host computer 16.

In block S61, the detection system 160 calculates a quantity of different pixels between the current image of the detection region and the stored image of the detection region.

In block S62, the detection system 160 determines if the quantity of the different pixels is greater than the preset threshold value. If the quantity of the different pixels is greater than the preset threshold value, the procedure goes to block S63. If the quantity of the different pixels is less than or equal to the preset threshold value, the procedure returns to block S60.

In block S63, the detection system 160 detects a human or a moving object in the different pixels using a human detection method or a moving object detection method.

In block S64, the detection system 160 determines if the human or the moving object is detected. If the human and the moving object are not detected within a determined time period (e.g., five minutes), the procedure goes to block S65. Otherwise, if the human or the moving object is detected, the procedure returns to block S60.

In block S65, the detection system 160 determines that the leaving object is detected. As shown in FIG. 10, “C1” represents the stored image of the detection region, “C2” represents a current image of the detection region with a human detected, “C3” represents a next current image of the detection region with a human not detected, “C4” represents a display interface on the display screen 125 of the electronic device 12. A leaving object of “C30” is detected in the current image “C3.”

It should be emphasized that the above-described embodiments of the present disclosure, particularly, any embodiments, are merely possible examples of implementations, merely set forth for a clear understanding of the principles of the disclosure. Many variations and modifications may be made to the above-described embodiment(s) of the disclosure without departing substantially from the spirit and principles of the disclosure. All such modifications and variations are intended to be included herein within the scope of this disclosure and the present disclosure and protected by the following claims.

What is claimed is:

1. A method for monitoring a specified area using an electronic device, comprising:
determining a detection region and a detection mode of an image capturing device sent from the electronic device;
obtaining a current image of the detection region captured by the image capturing device after a preset time interval;
comparing the current image of the detection region with a stored image of the detection region to detect a missed object or a leaving object according to the detection mode; and
sending the current image to the electronic device upon the condition that the missed object or the leaving object is detected.

2. The method according to claim 1, further comprising:
setting a detection region in a captured image received from the image capturing device using a display screen of the electronic device, and sending the detection region to a host computer;
obtaining an image of the detection region captured by the image capturing device when the detection region is set, and storing the image of the detection region in a storage device of the host computer; and
selecting a detection mode of the detection region from a storage device of the electronic device, and sending the detection mode of the detection region to the host computer.

3. The method according to claim 1, wherein the detection mode comprises a missed object detection mode and a leaving object detection mode.

4. The method according to claim 3, wherein the step of comparing the current image of the detection region with a stored image of the detection region to detect a missed object comprises:
reading the stored image of the detection region from a storage device of the host computer;
calculating a quantity of different pixels between the current image of the detection region and the stored image of the detection region;
determining if the quantity of the different pixels is greater than a preset threshold value; and
determine that the missed object is detected upon the condition that the quantity of the different pixels is greater than the preset threshold value.

5. The method according to claim 3, wherein the step of comparing the current image of the detection region with a stored image of the detection region to detect a leaving object comprises:
reading the stored image of the detection region from a storage device of the host computer;
calculating a quantity of different pixels between the current image of the detection region and the stored image of the detection region;
detecting a human or a moving object in the different pixels upon the condition that the quantity of the different pixels is greater than a preset threshold value; and
determine that the leaving object is detected upon the condition that the human and the moving object are not detected.

6. An electronic device, comprising:
a display screen;
a storage device;
at least one processor; and
one or more modules that are stored in the storage device and are executed by the at least one processor, the one or more modules comprising:
a setting module operable to set a detection region in a captured image of an image capturing device using a display screen of the electronic device, and send the detection region to a host computer;
a selection module operable to select a detection mode of the detection region, and send the detection mode of the detection region to the host computer; and
a display module operable to display an image sent from the host computer on the display screen upon the condition that the host computer detects a missed object or a leaving object in the image according to the detection region and the detection mode.

7. The electronic device according to claim 6, wherein the detection mode comprises a missed object detection mode and a leaving object detection mode.

8. The electronic device according to claim 6, wherein the detection region is set by:
logging on a setting interface of a detection system in the host computer using the electronic device;
selecting an image capturing device from a plurality of image capturing devices on the setting interface of the detection system; and
determining a selection mode to set a detection region in a captured image sent from the host computer.

9. The electronic device according to claim 8, wherein the selection mode comprises: a single selection mode, a multi-selection mode, an exclusive selection mode, an intersection selection mode, and a reverse selection mode.

10. A non-transitory storage medium having stored thereon instructions that, when executed by a processor of an electronic device, causes the processor to perform a method for monitoring a specified area using the electronic device, the method comprising:
determining a detection region and a detection mode of an image capturing device sent from the electronic device;
obtaining a current image of the detection region captured by the image capturing device after a preset time interval;
comparing the current image of the detection region with a stored image of the detection region to detect a missed object or a leaving object according to the detection mode; and
sending the current image to the electronic device upon the condition that the missed object or the leaving object is detected.

11. The non-transitory storage medium according to claim 10, wherein the method further comprising:
setting a detection region in a captured image received from the image capturing device using a display screen of the electronic device, and sending the detection region to a host computer;
obtaining an image of the detection region captured by the image capturing device when the detection region is set, and storing the image of the detection region in a storage device of the host computer; and
selecting a detection mode of the detection region from a storage device of the electronic device, and sending the detection mode of the detection region to the host computer.

12. The non-transitory storage medium according to claim 10, wherein the detection mode comprises a missed object detection mode and a leaving object detection mode.

13. The non-transitory storage medium according to claim 12, wherein the step of comparing the current image of the detection region with a stored image of the detection region to detect a missed object comprises:
reading the stored image of the detection region from a storage device of the host computer;
calculating a quantity of different pixels between the current image of the detection region and the stored image of the detection region;
determining if the quantity of the different pixels is greater than a preset value; and
determine that the missed object is detected upon the condition that the quantity of the different pixels is greater than the preset threshold value.

14. The non-transitory storage medium according to claim 12, wherein the step of comparing the current image of the detection region with a stored image of the detection region to detect a leaving object comprises:
reading the stored image of the detection region from a storage device of the host computer;
calculating a quantity of different pixels between the current image of the detection region and the stored image of the detection region;
detecting a human or a moving object in the different pixels upon the condition that the quantity of the different pixels is greater than a preset threshold value; and
determine that the leaving object is detected upon the condition that the human and the moving object are not detected.

15. The non-transitory storage medium according to claim 10, wherein the medium is selected from the group consisting of a hard disk drive, a compact disc, a digital video disc, and a tape drive.
